(19) United States
(12) Patent Application Publication
(10) Pub. No.: US 2023/0192071 A1
(43) Pub. Date: Jun. 22, 2023

(54) VEHICLE TRANSPORT MANAGEMENT DEVICE, VEHICLE TRANSPORT MANAGEMENT METHOD AND VEHICLE TRANSPORT SYSTEM

(71) Applicant: TOYOTA JIDOSHA KABUSHIKI KAISHA, Aichi-ken (JP)

(72) Inventors: Masayuki ITOH, Nagoya-shi (JP); Iwao MAEDA, Nagoya-shi (JP); Tatsuya SUGANO, Susono-shi (JP); Norinao WATANABE, Susono-shi (JP); Yutaka NAKAMURA, Susono-shi (JP); Yoshikazu JIKUHARA, Susono-shi (JP); Yuki NISHIKAWA, Susono-shi (JP)

(21) Appl. No.: 18/068,523

(22) Filed: Dec. 20, 2022

(30) Foreign Application Priority Data
Dec. 22, 2021 (JP) 2021-208502

(51) Int. Cl. B60W 30/06; B60P 3/07; G05D 1/02

(52) U.S. Cl. CPC B60W 30/06; B60P 3/07; G05D 1/0212; B60W 2530/201; B60W 2556/45

(57) ABSTRACT

The vehicle transport management device includes a processor configured to acquire vehicle information relating to a vehicle to be transported, and select a particular type of vehicle transport device from the plurality of types of vehicle transport devices as a vehicle transport device for transporting the vehicle based on the vehicle information.

### FIELD

The present disclosure relates to a vehicle transport management device, a vehicle transport management method, and a vehicle transport system.

### BACKGROUND

Conventionally, a vehicle transport device for transporting an unmanned vehicle for parking or the like is known. For example, Patent Document 1 describes that a self-propelled vehicle transport device transports a vehicle by lifting the vehicle through the tires of the vehicle.

In the vehicle transport device described in Patent Document 1, by expanding and contracting the arm connecting the two support portions for supporting the front and rear tires of the vehicle, it is possible to convey vehicles having different wheel bases.

### [CITATIONS LIST]

### [Patent Literature]

[PTL 1] U.S. Pat. No. 10590669

### SUMMARY

### [Technical Problem]

However, there is a limit to the length of the wheelbase that can be accommodated by the expansion and contraction of the arm. In addition, when a heavy vehicle is transported, there is a possibility that the vehicle cannot be lifted by the vehicle transport device or the conveyance speed of the vehicle is significantly reduced. Therefore, when only one type of vehicle transport device is used for various types of vehicles, it is difficult to realize smooth vehicle transport.

Therefore, an object of the present disclosure is to provide a smooth vehicle transport when various types of vehicles are transported using a vehicle transport device.

### [Solution to Problem]

The summary of the present disclosure is as follows.

(1) A vehicle transport management device for managing a plurality of types of vehicle transport devices having different transport characteristics, comprising a processor configured to: acquire vehicle information relating to a vehicle to be transported; and select a particular type of vehicle transport device from the plurality of types of vehicle transport devices as a vehicle transport device for transporting the vehicle based on the vehicle information.

(2) The vehicle transport management device described in above (1), wherein the processor is configured to acquire the vehicle information based on an image generated by a camera installed around the vehicle.

(3) The vehicle transport management device described in above (2), wherein the processor is configured to acquire position information of the vehicle and identify the camera based on the position information.

(4) The vehicle transport management device described in any one of above (1) to (3), wherein the vehicle information is a vehicle name, a type, or size-type information of the vehicle.

(5) The vehicle transport management device described in any one of above (1) to (3), wherein the vehicle information includes at least one of a vehicle width, a vehicle length, a tire inch size, and a wheel base of the vehicle.

(6) The vehicle transport management device described in any one of above (1) to (5), wherein the processor is configured to select a particular type of a parking space from a plurality of types of predetermined parking spaces as a parking space to which the vehicle is transported based on the vehicle information.

(7) A vehicle transport management method executed by a computer for managing a plurality of types of vehicle transport devices having different transport characteristics, comprising: acquiring vehicle information relating to a vehicle to be conveyed; and selecting a particular type of vehicle transport device from the plurality of types of vehicle transport devices as a vehicle transport device for transporting the vehicle based on the vehicle information.

(8) A vehicle transport system comprising: a plurality of types of vehicle transport devices having different transport characteristics; and a server configured to communicate with each of the plurality of types of vehicle transport devices, wherein the server comprises a processor configured to: acquire vehicle information relating to a vehicle to be transported; and select a particular type of vehicle transport device from the plurality of types of vehicle transport devices as a vehicle transport device for transporting the vehicle based on the vehicle information.

According to the present disclosure, it is possible to provide a smooth vehicle transport when various types of vehicles are transported using a vehicle transport device.

### BRIEF DESCRIPTION OF DRAWINGS

FIG. 1 is a schematic configuration diagram of a vehicle transport system according to a first embodiment of the present disclosure.

FIG. 2A is a side view of a vehicle transport device when a vehicle is not supported.

FIG. 2B is a side view of the vehicle transport device when supporting a vehicle.

FIG. 3A shows a top view of the vehicle transport device when a vehicle is not supported.

FIG. 3B is a top view of the vehicle transport device when supporting a vehicle.

FIG. 4 is a diagram schematically showing a part of the configuration of a vehicle transport device.

FIG. 5 is a diagram schematically showing a configuration of a server.

FIG. 6 is a diagram showing an example situation in which a vehicle transport service is provided.

FIG. 7 is a functional block diagram of a processor of the server.

FIG. 8 is a flowchart showing a control routine of a vehicle transport process according to the first embodiment.

FIG. 9 is a flowchart showing a control routine of a vehicle transport process according to a second embodiment.

### DESCRIPTION OF EMBODIMENTS

Hereinafter, embodiments of the present disclosure will be described in detail with reference to the drawings. In the following description, like components are denoted by the same reference numerals.

### <First Embodiment>

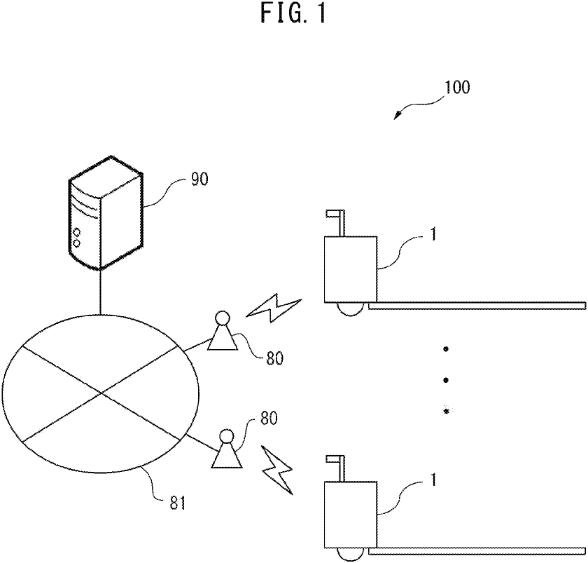

First, a first embodiment of the present disclosure will be described with reference to FIGS. 1 to 8. FIG. 1 is a schematic configuration diagram of a vehicle transport system 100 according to a first embodiment of the present disclosure. As shown in FIG. 1, the vehicle transport system 100 includes a plurality of vehicle transport devices 1 and a server 90. The server 90 is configured to communicate with each of the plurality of vehicle transport devices 1 via radio base stations 80, such as macrocells or small cells, and a communication network 81, such as an Internet-based network or a carrier network.

The vehicle transport system 100 provides a vehicle transport service using the vehicle transport devices 1. Specifically, the vehicle transport system 100 transports a user’s vehicle using the vehicle transport device 1 in response to a transport request from the user.

Vehicle transport device 1 transports a vehicle by traveling on the road while supporting the vehicle. In particular, in the present embodiment, the vehicle transport device 1 transports the vehicle by autonomous driving. That is, the vehicle transport device 1 is a self-propelled vehicle transport device.

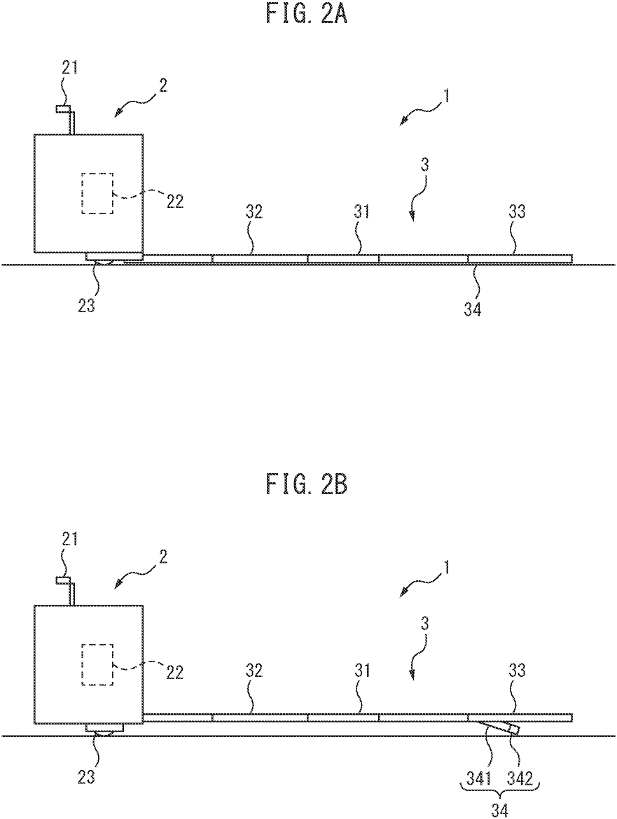

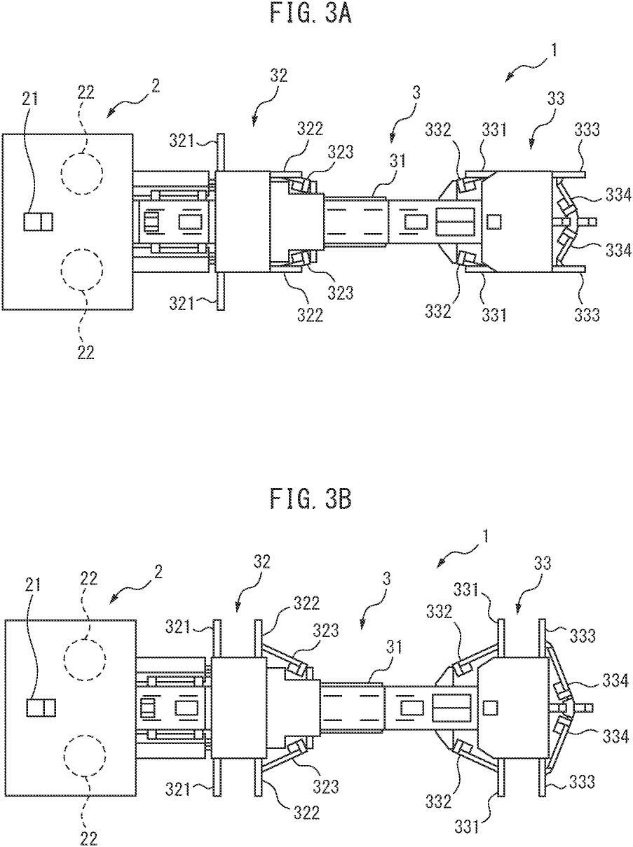

Hereinafter, the configuration of the vehicle transport device 1 will be described. FIG. 2A is a side view of the vehicle transport device 1 when the vehicle transport device 1 is not supporting a vehicle, and FIG. 2B is a side view of the vehicle transport device 1 when the vehicle transport device 1 is supporting a vehicle. FIG. 3A is a top view of the vehicle transport device 1 when the vehicle transport device 1 is not supporting a vehicle, and FIG. 3B is a top view of the vehicle transport device 1 when the vehicle transport device 1 is supporting a vehicle. As shown in FIGS. 2A to 3B, the vehicle transport device 1 includes a body portion 2 and a carriage portion 3 extending from the body portion 2.

The body portion 2 includes a lidar (LIDAR: Laser Imaging Detection And Ranging)) 21, two motors 22, and two front tires 23. The lidar 21 detects peripheral information (obstacle, road surface information, etc.) of the vehicle transport device 1 for autonomous driving of the vehicle transport device 1. The two motors 22 are each driven by electric power supplied from a battery (not shown) housed in the body portion 2 and rotationally drive the two front tires 23. That is, the two motors 22 outputs the power for traveling of the vehicle transport device 1 and functions as a driving device of the vehicle transport device 1.

The carriage portion 3 supports the vehicle to be transported, that is, the vehicle to be transported by the vehicle transport device 1. Specifically, the carriage portion 3 extends into the space between the lower part portion of the vehicle and the road surface from the front or rear of the vehicle, and supports the vehicle by lifting the tires of the vehicle.

The carriage portion 3 includes a telescopic arm 31, a front support portion 32, a rear support portion 33, and a lift portion 34. The telescopic arm 31 extends from the body portion 2, and the front support portion 32, the rear support portion 33 and the lift portion 34 is attached to the telescopic arm 31. The front support portion 32 and the rear support portion 33 are spaced apart in the extending direction of the telescopic arm 31 (longitudinal direction), and the lift portion 34 is disposed at the same position as the rear support portion 33 in the extending direction of the telescopic arm 31. The front support portion 32 supports one tire of the front tire and the rear tire of the vehicle to be transported, and the rear support portion 33 supports the other tire of the front tire and the rear tire of the vehicle to be transported.

The telescopic arm 31 contributes to the strength of the carriage portion 3, and adjusts the distance between the front support portion 32 and the rear support portion 33. For example, the telescopic arm 31 is driven by a linear actuator and is extendable and retractable so that the distance between the front support portion 32 and the rear support portion 33 varies. The telescopic arm 31 expands and contracts between a retracted position where the distance between the front support portion 32 and the rear support portion 33 is the shortest, and an extended position where the distance between the front support portion 32 and the rear support portion 33 is the longest.

Front support portion 32 has a pair of fixing clamp arms 321, a pair of first movable clamp arms 322, and a pair of first linear actuators 323. The pair of fixing clamp arm 321 and the pair of first movable clamp arms 322 are spaced apart in the extending direction of the telescopic arm 31. The pair of fixing clamp arms 321 are disposed closer to the body portion 2 than the pair of first movable clamp arms 322, and extend perpendicularly to the telescopic arm 31. On the other hand, the pair of first movable clamp arms 322 are coupled to the pair of first linear actuators 323 and are rotated by the reciprocating motion of the pair of first linear actuators 323. In the present embodiment, the pair of first movable clamp arms 322 are rotated 90 degrees between the closed position parallel to the telescopic arm 31 (FIG. 3A) and the open position perpendicular to the telescopic arm 31 (FIG. 3B).

The rear support portion 33 has a pair of second movable clamp arms 331, a pair of second linear actuators 332, a pair of third movable clamp arms 333, and a pair of third linear actuators 334. The pair of second movable clamp arms 331 and the pair of third movable clamp arms 333 are spaced apart in the extending direction of the telescopic arm 31. The pair of second movable clamp arms 331 are coupled to the pair of second linear actuators 332 and are rotated by reciprocating motion of the pair of second linear actuators 332. In the present embodiment, the pair of second movable clamp arms 331 are rotated 90 degrees between the closed position parallel to the telescopic arm 31 (FIG. 3A), and the open position perpendicular to the telescopic arm 31 (FIG. 3B). On the other hand, the pair of third movable clamp arms 333 are coupled to the pair of third linear actuator 334 and are rotated by the reciprocating motion of the pair of third linear actuators 334. In the present embodiment, the pair of third movable clamp arms 333 are rotated 90 degrees between the closed position parallel to the telescopic arm 31 (FIG. 3A), and the open position perpendicular to the telescopic arm 31 (FIG. 3B).

The lift portion 34 has a pivot arm 341 and four rear tires 342 attached to the distal end of the pivot arm 341. The pivot arm 341 is driven by, for example, a motor, and rotates relative to the telescopic arm 31 with the rear tires 342 in contact with the road surface. The pivot arm 341 rotates between a stationary position parallel to the telescopic arm 31 (FIG. 2A) and the lift position obliquely with respect to the telescopic arm 31 (FIG. 2B) such that the distance between the telescopic arm 31 and the road surface varies.

The vehicle transport device 1, when not supporting a vehicle, becomes the state shown in FIG. 2A and FIG. 3A. That is, the telescopic arm 31 is positioned in the retracted position, the first movable clamp arms 322, the second movable clamp arms 331 and the third movable clamp arms 333 are positioned in the closed position, and the pivot arm 341 is positioned in the stationary position. On the other hand, the vehicle transport device 1 becomes the state shown in FIG. 2B and FIG. 3B when supporting a vehicle. That is, the telescopic arm 31 is located in the extended position, the first movable clamp arms 322, the second movable clamp arms 331 and the third movable clamp arms 333 are located in the open position, and the pivot arm 341 is located in the lift position.

Hereinafter, the operation of the vehicle transport device 1 when the vehicle transport device 1 conveys a vehicle will be described. Initially, the vehicle transport device 1 approaches the vehicle such that the carriage portion 3 is inserted between the vehicle and the road surface through the space between the left and right front tires of the vehicle from the front of the vehicle. At this time, the vehicle transport device 1 moves relative to the vehicle so that the telescopic arm 31 is positioned on the vehicle width centerline. When the rear support portion 33 passes beyond the front tires and is positioned between the front tires and the rear tires, the second movable clamp arms 331 of the rear support portion 33 are rotated from the closed position to the open position. Then, the vehicle transport device 1 moves rearward of the vehicle until the fixing clamp arms 321 of the front support portion 32 are in contact with the front tires of the vehicle.

When the fixing clamp arms 321 abut the front tires of the vehicle, the telescopic arm 31 is extended until the second movable clamp arms 331 in the open position abut the rear tires of the vehicle. Thereafter, in a state where the fixing clamp arms 321 are in contact with the front tires of the vehicle and the second movable clamp arms 331 are in contact with the rear tires of the vehicle, the first movable clamp arms 322 of the front support portion 32 and the third movable clamp arms 333 of the rear support portion 33 are rotated from the closed position to the open position. As a result, the front tires of the vehicle are clamped by the fixing clamp arms 321 and the first movable clamp arms 322, while the rear tires of the vehicle are clamped by the second movable clamp arms 331 and the third movable clamp arms 333.

With all tires of the vehicle clamped, the pivot arm 341 of the lift portion 34 is rotated from the stationary position to the lift position. As a result, the tires of the vehicle are separated from the road surface, and the vehicle is supported by the carriage portion 3. The vehicle transport device 1 moves to the target position (e.g., parking space) by autonomous running with the carriage portion 3 supporting the vehicle. At the target position, the vehicle is unloaded from the vehicle transport device 1 in a procedure opposite to the order procedure above.

In the above example, although the carriage portion 3 is inserted below the vehicle from the front of the vehicle, the carriage portion 3 may be inserted below the vehicle from the rear of the vehicle. In this case, the rear tires of the vehicle are clamped by the fixing clamp arms 321 and the first movable clamp arms 322, while the front tires of the vehicle are clamped by the second movable clamp arms 331 and the third movable clamp arms 333.

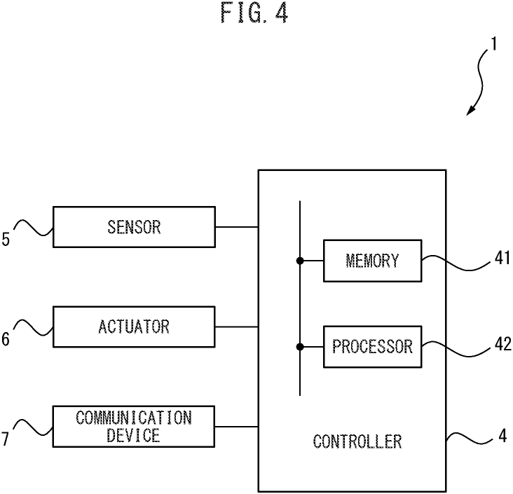

FIG. 4 schematically shows a part of the configuration of the vehicle transport device 1. As shown in FIG. 4, the vehicle transport device 1 includes a controller 4, a sensor 5, an actuator 6 and a communication device 7.

The controller 4 is, for example, a general-purpose computer, and performs various controls of the vehicle transport device 1. The controller 4 is housed in the body portion 2, and the sensor 5, the actuator 6 and the communication device 7 are electrically connected to the controller 4. The controller 4 is an exemplary control device of the vehicle transport device 1.

As shown in FIG. 4, the controller 4 includes a memory 41 and a processor 42. The memory 41 and the processor 42 are connected to each other via signal lines.

The memory 41 includes, for example, a volatile semiconductor memory (e.g., RAM) and a nonvolatile semiconductor memory (e.g., ROM). The memory 41 stores computer programs executed by the processor 42, various data used when various processes are executed by the processor 42, and the like.

The processor 42 includes one or a plurality of CPUs (Central Processing Unit) and peripheral circuits thereof, and executes various processes. The processor 42 may further include an arithmetic circuit such as a logical arithmetic unit or a numerical arithmetic unit.

The sensor 5 includes a peripheral information detecting device including the lidar 21 described above, and a Global Navigation Satellite System (GNSS) receiver for detecting the present position of the vehicle transport device 1. The output of the sensor 5 is sent to the controller 4, and the controller 4 controls the autonomous driving of the vehicle transport device 1 based on the output of the sensor 5. Note that the number and arrangement of the lidar 21 may be different from those described above. Further, the vehicle transport device 1 may include a rider, a millimeter-wave radar, a camera, an ultrasonic sensor, or any combinations thereof as the peripheral information detecting device.

The actuator 6 includes a motor 22, a linear actuator for expanding and contracting the telescopic arm 31, first linear actuators 323, second linear actuators 332, third linear actuators 334, and a motor for rotating the pivot arm 341. The controller 4 operates the actuator 6 based on the output of the sensor 5 or the like.

The communication device 7 allows communication between the vehicle transport device 1 and the server 90. For example, the communication device 7 is a wide area communication device accessible to the radio base station 80. The communication device 7 may be a WiFi module accessible to a WiFi router. In this case, the vehicle transport device 1 communicates with the server 90 without going through the radio base station 80.

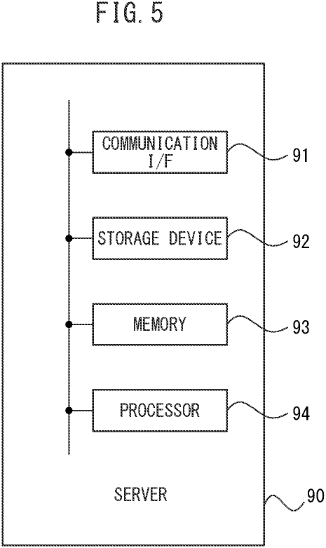

FIG. 5 is a diagram schematically showing a configuration of the server 90. The server 90 includes a communication interface 91, a storage device 92, a memory 93, and a processor 94. The communication interface 91, the storage device 92, and the memory 93 are connected to processor 94 via signal lines. The server 90 may further include an input device such as a keyboard and a mouse, an output device such as a display, and the like. The server 90 may include a plurality of computers.

The communication interface 91 includes an interface circuit for connecting the server 90 to the communication network 81. The server 90 communicates with each of the plurality of vehicle transport devices 1 via the communication network 81. The communication interface 91 is an example of a communication portion of the server 90.

The storage device 92 includes, for example, a hard disk drive (HDD), a solid-state drive (SDD), or an optical recording medium and its accessing device. The storage device 92 stores various data, for example, information of the vehicle transport device 1, such as identifying information and position information, and computer programs for the processor 94 to execute various processes. The storage device 92 is an example of a storage portion of the server 90.

The memory 93 includes a non-volatile semiconductor memory such as RAM. The memory 93 temporarily stores, for example, various data used when various processes are executed by the processor 94. The memory 93 is another example of a storage portion of the server 90.

The processor 94 includes one or a plurality of CPUs and peripheral circuits thereof, and executes various processes. It should be noted that the processor 94 may further include other arithmetic circuits, such as a logical arithmetic unit, a numerical arithmetic unit, or a graphic processing unit.

The server 90 manages a plurality of vehicle transport devices 1 to provide vehicle transport service to users. That is, the server 90 is an example of the vehicle transport management device that manages a plurality of vehicle transport devices 1. The server 90 dispatches the vehicle transport device 1 for transporting a vehicle to a vehicle stop location in response to a transfer request from a user.

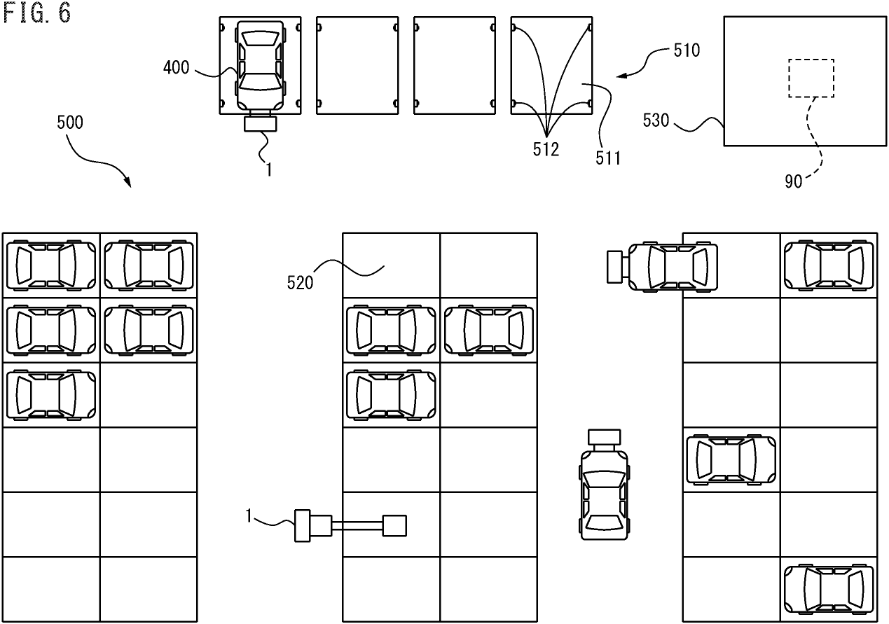

FIG. 6 is a diagram showing an example of a situation in which a vehicle transport service is provided. In the example of FIG. 6, the vehicle transport service is provided in a parking lot 500, and parking of a vehicle 400 is performed by the vehicle transport device 1 in place of the driver of the vehicle 400. The parking lot 500 is, for example, a parking lot of an airport, a station, an amusement park, a hospital, a stadium, a shopping center, or the like. The parking lot 500 has a boarding place 510 for the occupant of the vehicle 400 to get on and off from the vehicle 400, and a plurality of parking spaces 520 in which the vehicle 400 is parked. The boarding place 510 is provided near the entrance of the parking lot 500 and has a plurality of storage spaces 511 (four storage spaces in the example of FIG. 6). Each of the plurality of storage spaces 511 may be an open space or a garage-like space that can be opened and closed.

In the parking lot 500, the vehicle transport is performed by a plurality of (four in the example of FIG. 6) vehicle transport devices 1. The server 90 is located in a parking control center 530 that manages the parking lot 500, and manages the plurality of vehicle transport devices 1.

An occupant of the vehicle 400 utilizing the vehicle transport service in the parking lot 500 stops the vehicle 400 at the boarding place 510 in the parking lot 500, specifically an empty storage space 511 not occupied by another vehicle. Thereafter, the occupant of the vehicle 400 gets off from the vehicle 400 and inputs the request information (identification information of the vehicle (information of the license plate, etc.), the desired delivery time of the vehicle 400, etc.) to an information reading device (not shown) provided in the boarding place 510. Note that the occupant of the vehicle 400 may enter the request information into the information reading device via short-range radio communication between a mobile terminal (smartphone, tablet terminal, or the like) and the information reading device, QR-code (registered trademark) displayed on the mobile terminal, or the like.

When the request information is input to the information reading device, the entry request notification including the request information is transmitted from the information reading device to the server 90 via the communication network 81 or the like. In response to the entry request notification, the server 90 transmits a transport instruction to one vehicle transport device 1 among the plurality of vehicle transport devices 1. The vehicle transport device 1 that has received the transport instruction from the server 90 moves to the boarding place 510, and places the unmanned vehicle 400 on the vehicle transport device 1 at the boarding place 510. The vehicle transport device 1 then transports the vehicle 400 to an empty parking space 520 and unloads the vehicle 400 from the vehicle transport device 1 so that the vehicle 400 fits in its parking space 520. As a result, the transport of the vehicle 400 is completed, and the vehicle 400 is parked in the parking lot 500. Note that the entry request notification may be transmitted to the server 90 from a portable terminal or the like of the user (a passenger of the vehicle 400).

On the other hand, when the desired delivery time of the vehicle 400 which is parked in the parking lot 500 approaches, the server 90 transmits a transport instruction to one vehicle transport device 1 of the plurality of vehicle transport devices 1 in order to unload the vehicle 400 from the parking lot 500. The vehicle transport device 1 which has received the transport instruction from the server 90 moves to the parking space 520 where the vehicle 400 is parked, and places the unmanned vehicle 400 in the parking space 520 on the vehicle transport device 1. The vehicle transport device 1 then transports the vehicle 400 to the boarding place 510 and unloads the vehicle 400 from the vehicle transport device 1 so that the vehicle 400 fits into an empty storage space 511. As a result, the transport of the vehicle 400 is completed, the occupant of the vehicle 400 receives the vehicle 400 at the boarding place 510.

According to the vehicle transport service as described above, since it is not necessary to secure a space for the occupant of the vehicle to perform the boarding and alighting operation in the parking space, it is possible to provide a large number of parking spaces within a predetermined area. Further, since the troublesome work associated with the parking, such as operating a vehicle to search for a parking space and park there is not imposed on the occupant of the vehicle, it is possible to increase the convenience of the parking, and thus it is possible to promote the use of the parking.

However, since various types of vehicles are assumed to utilize parking lots, the vehicle transport device 1 needs to carry various types of vehicles. The vehicle transport device 1, by changing the distance between the front support portion 32 and the rear support portion 33 by expanding and contracting the telescopic arm 31, can convey different vehicles having different wheel bases. However, there is a limit to the length of the corresponding wheel base by the expansion and contraction of the telescopic arm 31. Further, when the weight vehicle is transported, there is a possibility that it is impossible to lift the vehicle by the vehicle transport device 1, or the transport speed of the vehicle is significantly reduced. Therefore, when only one type of vehicle transport device 1 is used for various types of vehicles, it is difficult to realize a smooth vehicle transport.

Therefore, in the present embodiment, a plurality of types of vehicle transport devices 1 having different transport characteristics are prepared. That is, the vehicle transport system 100 includes a plurality of types of vehicle transport devices 1, and provides a vehicle transport service using a plurality of types of vehicle transport devices 1. For example, different transport characteristics include the rated output of the drive device (specifically motor 22), the stiffness of the carriage portion 3 (e.g., load carrying capacity), the length of the wheelbase that can be accommodated, the force to lift the vehicle, the number of tires, and the like. If the stiffness of the carriage portion 3 differs, among the plurality of types of vehicle transport devices 1, for example, the material, the thickness, etc. of the carriage portion 3 (in particular, the telescopic arm 31) are changed. If the length of the corresponding wheel bases differs, the length of the telescopic arm 31 in the retracted position, the telescopic distance of the telescopic arm 31, or the like is changed between the plurality of types of the vehicle transport devices 1, for example. If the force to lift the vehicle differs, between the plurality of vehicle transport devices 1, for example, the rated output of the motor for driving the pivot arm 341 of the lift portion 34 is changed.

Depending on the characteristic of the vehicle being transported, the appropriate type of vehicle transport device 1 differs. For this reason, in the present embodiment, based on the vehicle information relating to the vehicle to be transported, a particular type of vehicle transport device 1 suitable for the transport of the vehicle is selected. Thus, even when various types of vehicles are transported using the vehicle transport device 1, it is possible to realize a smooth vehicle transport. Such a process is performed by the server 90 which manage a plurality of types of vehicle transport devices 1, as will be described below.

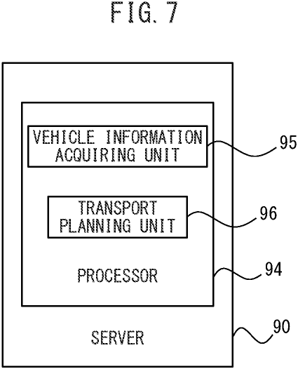

FIG. 7 is a functional block diagram of a processor 94 of a server 90. In the present embodiment, the processor 94 has a vehicle information acquiring unit 95 and a transport planning unit 96. The vehicle information acquiring unit 95 and the transport planning unit 96 are functional modules implemented by executing a computer program stored in the memory 93 of the server 90 by the processor 94 of the server 90. Each of these functional modules may be realized by a dedicated arithmetic circuit provided in the processor 94.

The vehicle information acquiring unit 95 acquires vehicle information relating to the vehicle to be transported. The transport planning unit 96 creates a transport plan of the vehicle to be transported. For example, the transport planning unit 96 selects a particular type of the vehicle transport device 1 among the plurality of types of the vehicle transport device 1 as the vehicle transport device for conveying the vehicle to be conveyed.

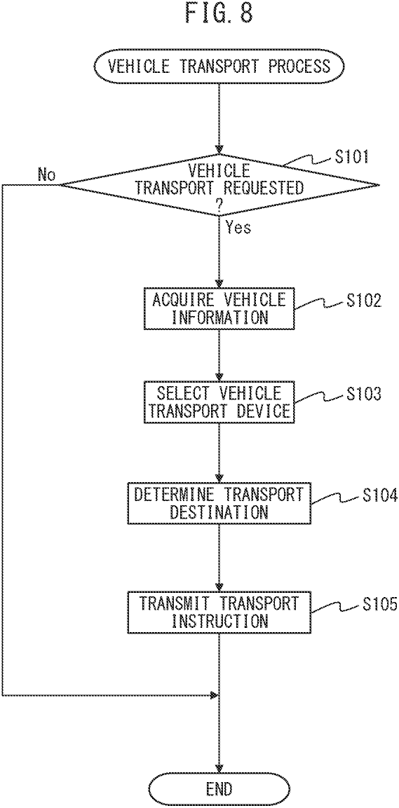

Hereinafter, referring to FIG. 8, a control flow when the vehicle is transported by the vehicle transport device 1 will be described in detail. FIG. 8 is a flowchart showing a control routine of the vehicle transport process according to the first embodiment. The control routine is executed by the processor 94 of the server 90 in accordance with a computer program stored in the memory 93 of the server 90.

First, in step S101, the vehicle information acquiring unit 95 determines whether or not vehicle transport is requested. For example, the vehicle information acquiring unit 95 determines that the vehicle transport is requested when the entry request notification is transmitted from the information reading device to the server 90, or when the time from the present time to the desired delivery time of the parked vehicle reaches a predetermined time. If it is determined in step S101 that the vehicle transport is not requested, the control routine ends. On the other hand, if it is determined in step S101 that the vehicle transport is requested, the control routine proceeds to step S102.

In step S 102, the vehicle information acquiring unit 95 acquires vehicle information relating to the vehicle to be conveyed (hereinafter, simply referred to as “vehicle information”). For example, if the vehicle is transported for entry of the vehicle, the vehicle information acquiring unit 95 acquires the vehicle information based on the image generated by cameras installed around the vehicle to be transported. In the example shown in FIG. 6, cameras 512 are provided at four corners of the storage space 511 of the boarding place 510, and the outputs of the cameras 512 are transmitted to the server 90 via the communication network 81 or the like. That is, the vehicle information acquiring unit 95 acquires vehicle information based on the images generated by the cameras 512.

The vehicle information is, for example, information indicating the size of a vehicle to be conveyed. As a specific example, the vehicle information is the vehicle name, type or size type information of the vehicle (e.g., large-sized-vehicle, medium-sized vehicle, ordinary-sized vehicle, etc.), or includes at least one of the vehicle width, vehicle length, tire inch size, and wheel base of the vehicle. The vehicle information is acquired by using, for example, a classifier that has been learned in advance so as to output predetermined vehicle information based on images generated by the cameras 512. The example of such a classifier include a machine learning model such as a neural network, a support vector machine, and a random forest.

Incidentally, a weight sensor (not shown) may be provided in each of the plurality of storage spaces 511, the weight of the vehicle detected by the weight sensor may be transmitted to the server 90 as vehicle information. Further, information input in advance to a terminal device such as an HMI (Human Machine Interface) of a vehicle or a mobile terminal of a user, or information input directly to an information reading device provided in the boarding place 510 may be transmitted to the server 90 as vehicle information.

Further, the vehicle information acquired at the time of entry of the vehicle is stored in the storage device 92 or the memory 93 of the server 90 and is read by the vehicle information acquiring unit 95 when the vehicle is transported for delivery of the vehicle. That is, when the vehicle is transported for delivery of the vehicle, the vehicle information acquiring unit 95 acquires the vehicle information from the storage device 92 or the memory 93 of the server 90.

Next, in the step S103, the transport planning unit 96 selects a particular type of vehicle transport device 1 from a plurality of types of vehicle transport devices 1 as the vehicle transport device for transporting the vehicle to be transported based on the vehicle information acquired by the vehicle information acquiring unit 95. For example, the correspondences between the vehicle information and the type of the vehicle transport device 1 are determined in advance and stored in the storage device 92 or the storage device 93 of the server 90 as databases. In this case, the transport planning unit 96 selects a particular type of the vehicle transport device 1 from the plurality of types of the vehicle transport devices 1 based on the vehicle information according to the corresponding relationship described in the database.

Then, in step S 104, the transport planning unit 96 determines the transport destination of the vehicle to be transported. If the vehicle is transported for delivery of the vehicle, the vehicle information acquiring unit 95 selects an empty storage space 511 of the boarding place 510 as the transport destination of the vehicle. Whether or not the storage space 511 is empty is determined based on, for example, an image generated by the camera 512. Incidentally, this determination may be performed based on the output of a vehicle detecting device such as a metal detector provided in the storage space 511.

On the other hand, if the vehicle is transported for entry of the vehicle, the transport planning unit 96 selects an empty parking space 520 as the transport destination of the vehicle. Whether or not the parking space 520 is empty is determined based on, for example, past entry and delivery information. Incidentally, this determination may be performed based on the output of a vehicle detecting device such as a metal detector or a camera provided in the parking space 520.

Further, in order to accommodate the parking of different sized vehicles, there is a case where a plurality of types of parking spaces having different sizes are provided in the parking lot 500. In this case, based on the vehicle information, the transport planning unit 96 selects, as the parking space where the vehicle to be transported is transported, a particular type of parking space from a plurality of types of parking spaces. Thus, it is possible to suppress the mismatch between the vehicle to be transported and the parking space, and thus it is possible to promote smooth vehicle transport.

Next, in step S105, the transport planning unit 96 transmits a transport instruction to the particular type of vehicle transport device 1 selected in step S 103. The transport instruction includes the current position of the vehicle to be transported (for example, the identification number of the storage space 511 or the parking space 520), the information of the transport destination (for example, the identification number of the storage space 511 or the parking space 520), and the like. After step S 105, the control routine ends.

### <Second Embodiment>

The vehicle transport system and the vehicle transport management device according to the second embodiment are basically the same as the vehicle transport system and the vehicle transport management device according to the first embodiment, except for the following points. Therefore, the second embodiment of the present disclosure will be described below focusing on portions different from the first embodiment.

In the first embodiment, a plurality of types of vehicle transport devices 1 are located in a particular facility such as a parking lot, and transport vehicles from a predetermined boarding place within the facility. On the other hand, in the second embodiment, the plurality of types of vehicle transport devices 1 are arranged in a predetermined target area, and transports vehicles from any place in the target area. The target area is a range surrounded by a predetermined boundary, and is, for example, a smart city defined as “a sustainable city or district in which management (planning, maintenance, management, management, etc.) is performed while utilizing new technologies such as Information and Communication Technology (ICT) for various problems of cities, and overall optimization is achieved”.

If performing the vehicle transport from any place, it is impossible to acquire the vehicle information using the device installed in advance to acquire the vehicle information of the vehicle to be transported. On the other hand, in a target area such as a smart city, data are collected from a number of cameras arranged in the target area in order to realize a safe and efficient urban life.

Therefore, in the second embodiment, the vehicle information acquiring unit 95 acquires the positional information of the vehicle to be transported, and based on the positional information, identifies the camera installed around the vehicle to be transported. Then, the vehicle information acquiring unit 95, based on the image generated by the camera, acquires the vehicle information of the vehicle to be transported. Thus, even when the vehicle is transported from any location, it is possible to dispatch a vehicle transport device 1 of an appropriate type to transport the vehicle based on the vehicle information acquired by the camera around the vehicle. Therefore, it is possible to suppress a mismatch between the vehicle to be transported and the vehicle transport device 1.

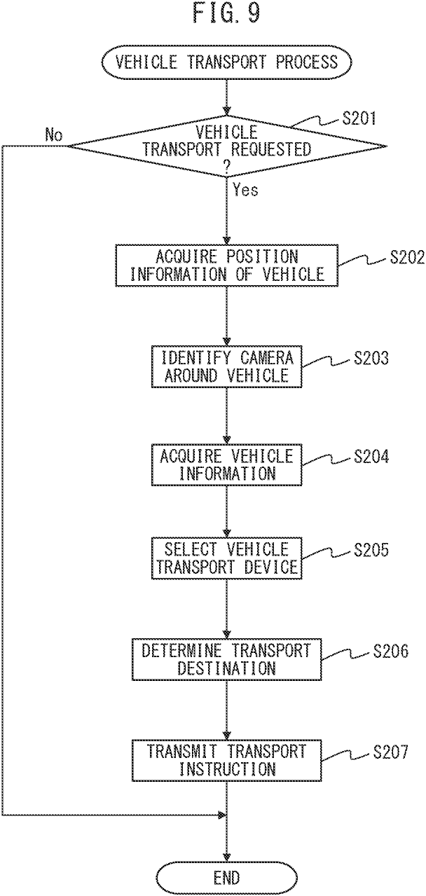

FIG. 9 is a flowchart showing a control routine of the vehicle transport process according to the second embodiment. The control routine is executed by the processor 94 of the server 90 in accordance with a computer program stored in the memory 93 of the server 90.

First, in step S201, the vehicle information acquiring unit 95 determines whether or not vehicle transport is requested. For example, when requesting vehicle transport, the user of the vehicle transport service inputs the request information to the terminal device by operating a terminal device such as the HMI of the vehicle or the mobile terminal of the user. The request information includes a desired parking place (user’s home, etc.), identification information of the vehicle (license plate information, etc.), and the like. When the user completes inputting the request information, the terminal device transmits the transport request notification including the request information to the server 90 via the radio base station 80 and the communication network 81.

Therefore, the vehicle information acquiring unit 95 determines that the vehicle transport is requested when the transport request notification is transmitted from the terminal device to the server 90. If it is determined in step S201 that the vehicle transport is not requested, the control routine ends. On the other hand, if it is determined in step S201 that the vehicle transport is requested, the control routine proceeds to step S202.

Next, in step S202, the vehicle information acquiring unit 95 acquires position information of the vehicle to be conveyed. The vehicle position information is included in the transport request notification transmitted from the terminal device to the server 90, and the vehicle position information is, for example, the present position information of the vehicle detected by a GNSS receiver provided in the terminal device.

Then, in step S203, the vehicle information acquiring unit 95, based on the positional information of the vehicle to be transported, identifies the camera around the vehicle to be transported. Specifically, the vehicle information acquiring unit 95 compares the position information of the vehicle to be transported with the position information of cameras in the target area, and identifies the camera closest to the vehicle to be transported. Incidentally, the cameras in the target area may include not only a fixed camera for capturing a predetermined range at all times but also a camera mounted on a vehicle or a drone.

Next, in step S204, the vehicle information acquiring unit 95 acquires vehicle information based on the image generated by the camera identified in step S203. Similar to the step S102 of FIG. 8, vehicle information is, for example, vehicle name, type or size-type information (e.g., large-sized-vehicle, medium-sized vehicle, ordinary-sized vehicle, etc.), or includes at least one of vehicle width, vehicle length, tire inch size, and wheel base.

Next, in the step S205, similarly to the step S103 of FIG. 8, the transport planning unit 96 selects a particular type of the vehicle transport device 1 from the plurality of types of the vehicle transport devices 1 as the vehicle transport device for transporting the vehicle to be transported based on the vehicle information acquired by the vehicle information acquiring unit 95.

Next, in step S206, the transport planning unit 96 determines the transport destination of the vehicle to be transported. For example, the transport planning unit 96 selects a desired parking location included in the transport request notification as a transport destination of the vehicle. Note that if the vehicle to be conveyed is a rental car or a share car that is discarded by the user, the transport planning unit 96 may select a predetermined accommodation location for accommodating the vehicle as the transport destination of the vehicle.

Next, in step S207, the transport planning unit 96 transmits a transport instruction to the particular type of vehicle transport device 1 selected in step S205. The transport instruction includes the current position of the vehicle to be transported, information of the transport destination, and the like. After step S207, the control routine ends.

Incidentally, if the size of the vehicle can be estimated based on the position information of the vehicle, for example, when the current position of the vehicle is an area dedicated to the large-sized vehicle (a parking lot, etc.), based on the position information of the vehicle, the transport planning unit 96 may select the vehicle transport device for transporting the vehicle. Further, instead of an image generated by a camera around a vehicle to be conveyed, information input in advance to a terminal device such as an HMI of the vehicle or a portable terminal of the user may be transmitted from the terminal device to the server 90 as vehicle information.

### <Other Embodiments>

While preferred embodiments of the present disclosure have been described above, the present disclosure is not limited to these embodiments, and various modifications and changes may be made within the scope of the appended claims. For example, the vehicle transported by the vehicle transport device 1 may include a motorcycle, a three-wheeled vehicle, a single passenger compact mobility, or the like.

Further, a computer program that causes a computer to realize the functions of each unit included in the processor 94 of the server 90 may be provided in a form stored in a computer-readable recording medium. The computer readable recording medium is, for example, a magnetic recording medium, an optical recording medium, or a semiconductor memory.

### [Description of Symbols]

1 Vehicle transport device
90 Server
94 Processor
95 Vehicle information acquiring unit
96 Transport planning unit

1. A vehicle transport management device for managing a plurality of types of vehicle transport devices having different transport characteristics, comprising a processor configured to:
acquire vehicle information relating to a vehicle to be transported; and
select a particular type of vehicle transport device from the plurality of types of vehicle transport devices as a vehicle transport device for transporting the vehicle based on the vehicle information.

2. The vehicle transport management device according to claim 1, wherein the processor is configured to acquire the vehicle information based on an image generated by a camera installed around the vehicle.

3. The vehicle transport management device according to claim 2, wherein the processor is configured to acquire position information of the vehicle and identify the camera based on the position information.

4. The vehicle transport management device according to claim 1, wherein the vehicle information is a vehicle name, a type, or size-type information of the vehicle.

5. The vehicle transport management device according to claim 1, wherein the vehicle information includes at least one of a vehicle width, a vehicle length, a tire inch size, and a wheel base of the vehicle.

6. The vehicle transport management device according to claim 1, wherein the processor is configured to select a particular type of a parking space from a plurality of types of predetermined parking spaces as a parking space to which the vehicle is transported based on the vehicle information.

7. A vehicle transport management method executed by a computer for managing a plurality of types of vehicle transport devices having different transport characteristics, comprising:
acquiring vehicle information relating to a vehicle to be conveyed; and
selecting a particular type of vehicle transport device from the plurality of types of vehicle transport devices as a vehicle transport device for transporting the vehicle based on the vehicle information.

8. A vehicle transport system, comprising:
a plurality of types of vehicle transport devices having different transport characteristics; and
a server configured to communicate with each of the plurality of types of vehicle transport devices, wherein
the server comprises a processor configured to:
acquire vehicle information relating to a vehicle to be transported; and
select a particular type of vehicle transport device from the plurality of types of vehicle transport devices as a vehicle transport device for transporting the vehicle based on the vehicle information.
